(19) United States
(12) Patent Application Publication
(10) Pub. No.: US 2008/0147908 A1
(43) Pub. Date: Jun. 19, 2008

(54) Direct Memory Access Controller with Error Check

(75) Inventors: Gregg D. Lahti, Gilbert, AZ (US); Joseph W. Triece, Phoenix, AZ (US); Rodney J. Pesavento, Chandler, AZ (US); Nilesh Rajbharti, Glendale, AZ (US); Steven Dawson, Chandler, AZ (US)

Correspondence Address: BAKER BOTTS, LLP, 910 LOUISIANA, HOUSTON, TX, 77002-4995, US

(73) Assignee: Microchip Technology Incorporated

(21) Appl. No.: 11/928,168

(22) Filed: Oct. 30, 2007

Related U.S. Application Data
(60) Provisional application No. 60/869,816, filed on Dec. 13, 2006.

(51) Int. Cl. G06F 13/28

(52) U.S. Cl. 710/23

(57) ABSTRACT

A direct memory access (DMA) controller may comprise a DMA bus, a memory coupled to the DMA bus, a DMA engine coupled with the DMA bus, a cyclic redundancy check (CRC) module coupled with the DMA engine, and a bus interface coupled to the DMA engine and the CRC module.

### CROSS-REFERENCE TO RELATED APPLICATIONS

This application claims the benefit of U.S. Provisional Application No. 60/869,816 filed on Dec. 13, 2006, entitled “PROGRAMMABLE N-BIT CRC GENERATOR UTILIZING DMA”, which is incorporated herein in its entirety.

### TECHNICAL FIELD

The technical field of the present application relates to a direct memory access controller.

### BACKGROUND

Direct memory access controller (DMA) are typically used in microprocessor systems, integrated microcontrollers, etc. DMA controllers are used to perform a data transfer from and to memory to and from a peripheral independently from the central processing unit of the computer system. To this end, a DMA controller can be seen as a second programmable processing unit with limited capabilities. Generally, a DMA controller is instructed to transfer a specific amount of data from a source location to a destination location. The source can be within a memory, for example, a data memory of a microcontroller, memory of a peripheral, or data generated by or accessible within a peripheral, such as an analog to digital converter, a port, a capture compare unit, etc. The destination can also be within a memory, thus, allowing high speed transfers within a memory device of a computer system or microcontroller. However, the destination can also be a peripheral, such as a digital to analog converter, a port, etc. To transfer data from a source to a destination the DMA controller must receive the respective source and destination addresses. In addition, each transfer length needs to be specified. To this end, the DMA controller needs to receive either the length of the data transfer or the start and end address of the data to be transferred.

Moreover, DMA controllers are used to support the central processing unit (CPU) in a system, in particular for lengthy data transfers. The CPU is then free to perform other functions. However, any type of transfer can be subject to interference and distortion. Tests to perform a redundancy checks are usually performed by the CPU and, thus, lengthen the transfer process.

### SUMMARY

According to an embodiment, a direct memory access (DMA) controller may comprise a DMA bus, a memory coupled to the DMA bus, a DMA engine coupled with the DMA bus, a cyclic redundancy check (CRC) module coupled with the DMA engine, and a bus interface coupled to the DMA engine and the CRC module.

According to another embodiment, a direct memory access (DMA) controller may comprise a bus matrix, a memory coupled to the bus matrix, a DMA engine coupled with the bus matrix, a programmable cyclic redundancy check (CRC) module coupled between the DMA engine and the bus matrix, and a bus interface coupled to the DMA engine and the CRC module.

According to another embodiment, a method of performing a direct memory access (DMA) transfer comprising the steps of a) initializing a DMA channel in a DMA controller; b) initializing a cyclic redundancy check (CRC) module coupled with the DMA controller; c) loading source data from a source address into the CRC module and starting a cyclic redundancy check algorithm on the loaded source data; d) incrementing the source address; and e) repeating steps c) and d) until a source end address has been reached.

Other technical advantages of the present disclosure will be readily apparent to one skilled in the art from the following figures, descriptions, and claims. Various embodiments of the present application may obtain only a subset of the advantages set forth. No one advantage is critical to the embodiments.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram of a first embodiment of a DMA controller;

FIG. 2 illustrates an embodiment of a programmable CRC controller;

FIG. 3 shows a flow chart of a typical CRC operation using the DMA controller according to an embodiment.

FIG. 4 illustrates a graph representing hardware efficiency of CRC time of RS-232 at 112 kbps, according to a specific example embodiment of this disclosure; and

FIG. 5 illustrates a graph representing hardware efficiency of CRC time of 512 kilobyte Flash memory, according to a specific example embodiment of this disclosure.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

### DETAILED DESCRIPTION

Conventional technologies do not provide for cyclic redundancy check (CRC) calculations within a DMA controller. Rather separate hardware or software-based operations are provided within the various peripheral modules. According to various embodiments, a programmable CRC generator is integrated as a single engine attached to multiple DMA channels which allows programmable CRC types as opposed to fixed CRC calculations.

According to further enhancements the CRC module in a DMA controller may be coupled between the DMA engine and the DMA bus. According to yet another enhancement, the DMA bus can be a bus matrix and the CRC module may be programmable. According to yet another enhancement, the CRC module may comprise a shift register having a plurality of shift cells and associated taps coupled with a tap multiplexer providing an output signal that is fed back to the shift register. According to yet another enhancement, the DMA controller may further comprise a plurality of XOR gates coupled with the plurality of taps and receiving the output signals of the tap multiplexer. According to yet another enhancement, the DMA controller may further comprise a plurality of select multiplexers each selecting an output of one of the plurality of XOR gates or the tap of a shift cell. According to yet another enhancement, the DMA controller may further comprise a control register for controlling the plurality of select multiplexers. According to yet another enhancement, the DMA controller may further comprise a register for controlling the tap multiplexer.

With respect to the various embodiments of methods of performing a DMA transfer, the step of loading source data may comprise the step of directly loading the source data into the CRC module. According to yet another enhancement, the step of loading source data may comprise the step of loading the source data into the DMA controller and subsequently from the DMA controller into the CRC module. According to yet another enhancement, the CRC module may comprise a shift register having a plurality of shift cells and associated taps coupled with a tap multiplexer providing an output signal that is fed back to the shift register. According to yet another enhancement, the CRC module may further comprises a plurality of XOR gates coupled with the plurality of taps and receiving the output signals of the tap multiplexer. According to yet another enhancement, the CRC module may further comprises a plurality of select multiplexers each selecting an output of one of the plurality of XOR gates or the tap of a shift cell. According to yet another enhancement, the step of initializing the CRC module may comprise the step of loading a feedback point into a control register for controlling the tap multiplexer. According to yet another enhancement, the step of initializing the CRC module may comprises the step of loading a polynomial length into a register for controlling the plurality of select multiplexers. According to yet another enhancement, the method may further comprise the step of writing a result of a CRC to a pre-determined memory location.

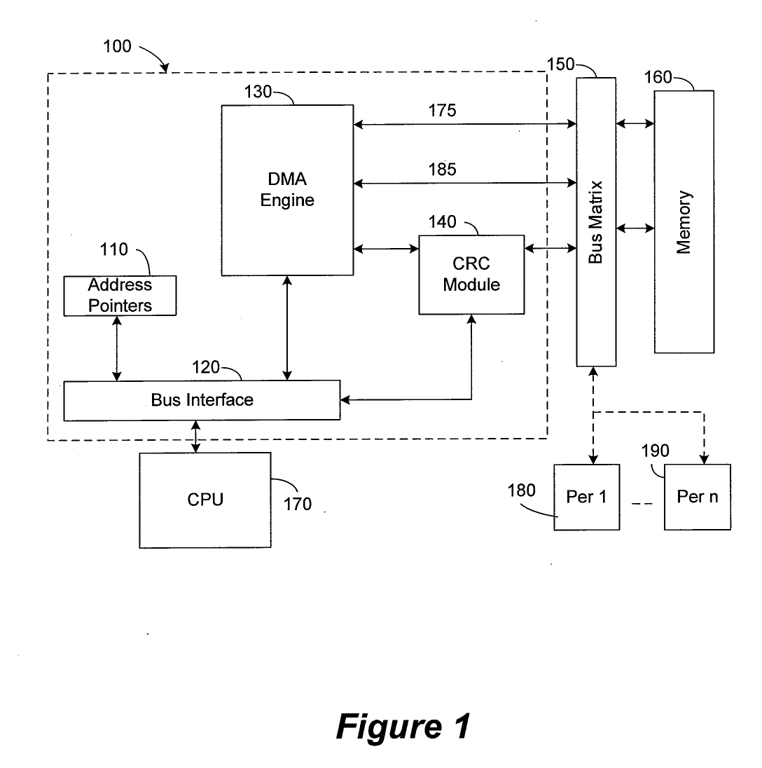

FIG. 1 shows a first embodiment of a direct memory access (DMA) controller 100 and its connection to a memory 160 and central processing unit (CPU) 170. A bus interface 120 is provided to couple the DMA controller to the central processing unit 170. The bus interface 120 allows for programming of respective address pointers 110 and for direct communication with the DMA engine 130. The DMA engine 130 is coupled through respective address and data lines 175, 185 with a bus matrix 150. The bus matrix 150 is used to couple any peripheral, memory, flash memory etc. In the embodiment shown in FIG. 1 only a memory block 160 is connected to the bus matrix. However, multiple types of memories and peripherals as shown with peripherals 180, 190 may be coupled to the bus matrix 150. For example, one of the peripherals can be a serial communication interface, such as an RS 232 interface, a universal serial bus (USB) or firewire interface. Thus, direct memory access transfers can be performed directly between such a serial interface and the memory 160. According to various embodiments, instead of a bus matrix 150, a single dedicated DMA bus or multiple busses may be used to connect different peripherals and memories to the DMA controller 100.

According to an embodiment, a cyclic redundancy check (CRC) module 140 is integrated within the DMA controller 100 and is coupled between the DMA engine 130 and the bus matrix 150 for performing a cyclic redundancy check. The CRC module is programmable and to this end coupled with the bus interface 120. Thus, the CPU 170 can access the CRC module 140 and program it according to a CRC specification as will be explained in more detail below. When activated for a channel, data can be routed directly through the CRC module 140 into the DMA engine 130 as opposed to directly loading them into the DMA engine through data lines 185. However, alternatively in another embodiment, the CRC module can be only coupled with the DMA engine 130. In such an embodiment, data is always first fed through the data lines 185 into the DMA engine 30 and then can be further loaded into the CRC module 140 through the respective coupling between the CRC module 140 and the DMA engine 130.

The DMA engine 130 may utilize an N-channel DMA controller which is capable of memory to memory, memory to peripheral, or peripheral to memory operations. Each channel is programmable individually and may comprise associated control, address and size registers. The CRC module 140 can be used under program control with any of the channels of the DMA controller. The CRC module 140 resources can be shared with each DMA channel. To this end, respective registers can be written and saved to control the CRC module 140. Thus, only a single CRC module is implemented. The CRC module 140 allows for the ability to perform cyclic redundancy check generation of memory regions or FLASH memory contents utilizing a hardware-based DMA operation. This provides faster throughput than programmed software methods. By implementing this as a programmable CRC tap of, for example, N to 16 bits as will be explained in more detail below, a user can implement any particular CRC algorithm required for communication protocols.

A DMA transfer may be performed with or without the inclusion of the CRC module. DMA transfers that do not require a CRC calculation will not be assigned the CRC module during transfer. For example moving data from one memory location to another would not require a CRC. A data transfer using a serial interface could be specified to transmit a CRC at the end of the transmission. In this example the CRC would be calculated as the data is sent or received, and the result compared. The DMA module has an additional mode which is a CRC only mode where data is NOT transferred, but is read and a CRC calculated on the data read. This can be used to verify the integrity of a block of data in memory. In another embodiment the CRC result data can be automatically written to some pre-determined location on completion of the calculation. For example, the result for each CRC can be written to consecutive addresses in a pre-determined memory location or a final result of a data transaction can be written to a predefined location.

Thus, a DMA transfer may be performed with or without the inclusion of the CRC module. For example, a data transfer using a serial interface provides for enough time between two consecutive data elements to perform a CRC algorithm on each transferred data element. Many other data transfers allow for the execution of a CRC algorithm between consecutive data elements. However, if a high speed transfer does not allow the execution of the respective CRC algorithm between consecutive data elements, the CRC algorithm can be run after a completed transfer. Thus, the CRC module can be used without performing an actual DMA transfer of data. For example, the CRC module can be used to check the integrity of any type of memory, such as Flash memory that has been programmed, by defining an address range.

The CRC generator may utilize a TAP register for programming the CRC algorithm, a read/write CRC register which may contain the initial preload of the CRC value and the final result after a CRC operation. The CRC/DMA engine side may utilize the DMA SRC/SIZE registers of the memory or FLASH region and length of the “read-only operation” to generate the CRC. A user-defined option allows use of the DMA DST register as a pointer to the address for which the CRC result could be written.

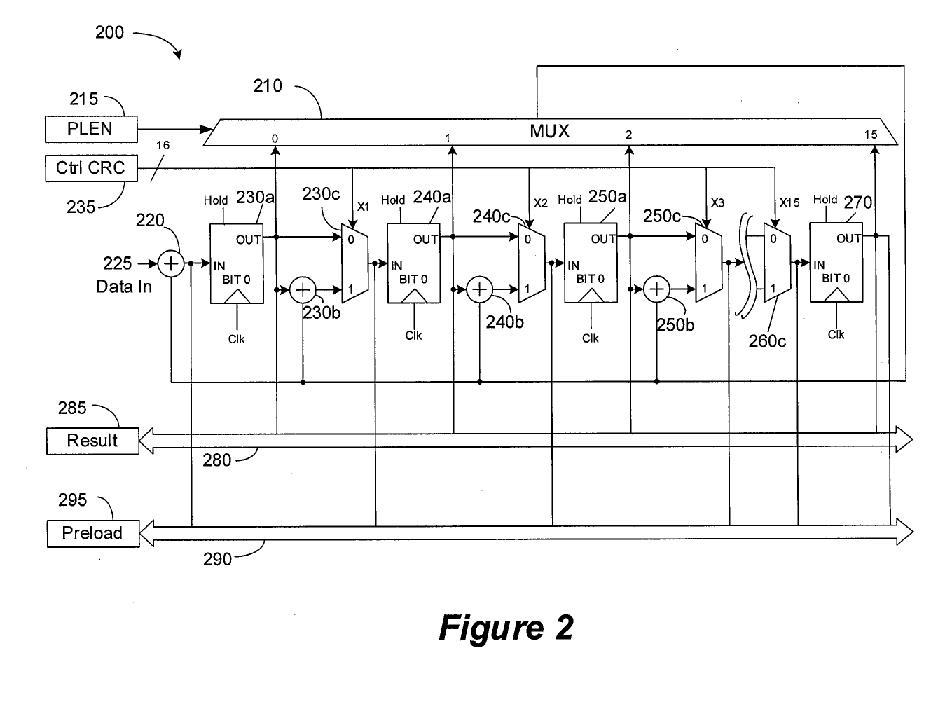

FIG. 2 shows an embodiment of CRC generator that can be used within a DMA controller. A TAP register is formed by shift register cells 230a, 240a, embodiment shown in FIG. 2 depicts certain sections of a 16 bit CRC generator. However, other configurations with 8 or 32 bits or any other size can be easily realized. The input of cell 230a is coupled with the output of XOR gate 220 which receives the serial data input signal 225 and the feedback output signal from multiplexer 210. The output of cell 230a is coupled with the first input of multiplexer 210, the first input of select multiplexer X1, the first input of XOR gate 230b, and the CRC Read bus 280. The second input of XOR gate 230b is coupled with the feedback output signal from multiplexer 210 and the output of XOR gate 230b with the second input of select multiplexer 230c. The output of select multiplexer 230c is coupled with the input of the next shift cell 240a and with the CRC Write bus 290. The next shift cells 240a . . . 250a are provided with respective XOR gates 240b . . . 250b and select multiplexers 240c . . . 260c and connected in the same way as cell 230a to respective inputs of multiplexer 210 and busses 280 and 290. The output of the last cell 270 is coupled with the last input of multiplexer 210, and CRC Read and Write busses 280 and 290. Multiplexer 210 is controlled by register 215 PLEN. Multiplexers 230c . . . 260c are controlled by register 235 CTRL CRC. CRC Read bus 280 can be coupled with register 285 containing the result and CRC Write bus 290 can be coupled to register 295 containing the preload value.

The multiplexer 210 is used to select the feedback point and effective length of the CRC generator through register PLEN. PLEN register 215 controls the length of the CRC generator 200 and is user selectable. The feedback data which is provided by the output of multiplexer 210 is XORed with the data currently in the CRC shift register 230a, 240a, 250a, 270 by means of the XOR gates 230b . . . 260c. Select multiplexers 230c, 240c, 250c and 260c are used to select whether the XOR data or the previous data in the shift register 230a, 240a, 250a, 270 is shifted on the next clock. CTRL CRC register 235 is used to configure which bits are shifted through and which bits take the feedback data XOR'ed with the previous data in the CRC generator which contains the X1 input of multiplexers 230c, 240c, 250c and 260c. CRC Write bus 290 can be used to pre-load the CRC 230a, 240a, 250a, 270 by means of preload register 295. CRC Read bus 280 can be used to read the value of the CRC generator. Data to be fed into the CRC is shifted into the CRC through XOR gate 220.

According to an embodiment as for example shown in FIG. 1, the CRC generator is arranged within the DMA controller and can be shared between the different DMA channels provided by the DMA controller. The combination of a CRC engine within a DMA controller prevents the requirement of N-byte-deep FIFO overhead, since there is a pure DMA operation in main memory. The various embodiments provide for an operation system-friendly method using buffers of memory, e.g., for real-time operating systems (RTOS), Linux, WindowsCE, etc. The CRC is programmable as explained above for memory segments to ensure data integrity, and provides for efficiency over software-based CRC calculations. CRC can also be used in communication protocols to verify data integrity. Depending on the applications, different CRC algorithms can be specified easily. For example, if the DMA controller is used for serial protocols having differing requirements, the CRC generator can be programmed, respectively. The arrangement shown in FIG. 2 provides for a linear feedback shift register (LFSR) with various configurations based on tap/XOR location in a LFSR-style chain. The CRC generator can also be utilized for memory/FLASH integrity checks. According to alternative embodiments, instead of using a result register 285, in an optional mode, a destination address of DMA channel can be set which contains the location for CRC result to be written. According to yet another embodiment, an interrupt can be generated when the DMA operation complete to indicate to the central processing unit that a DMA transfer has been completed. In addition, a variety of interrupt signals can be generated by the CRC generator. For example, a specific interrupt can be generated if an error during the CRC controlled transmission occurs. Also, a special interrupt could be generated upon a successful CRC transmission.

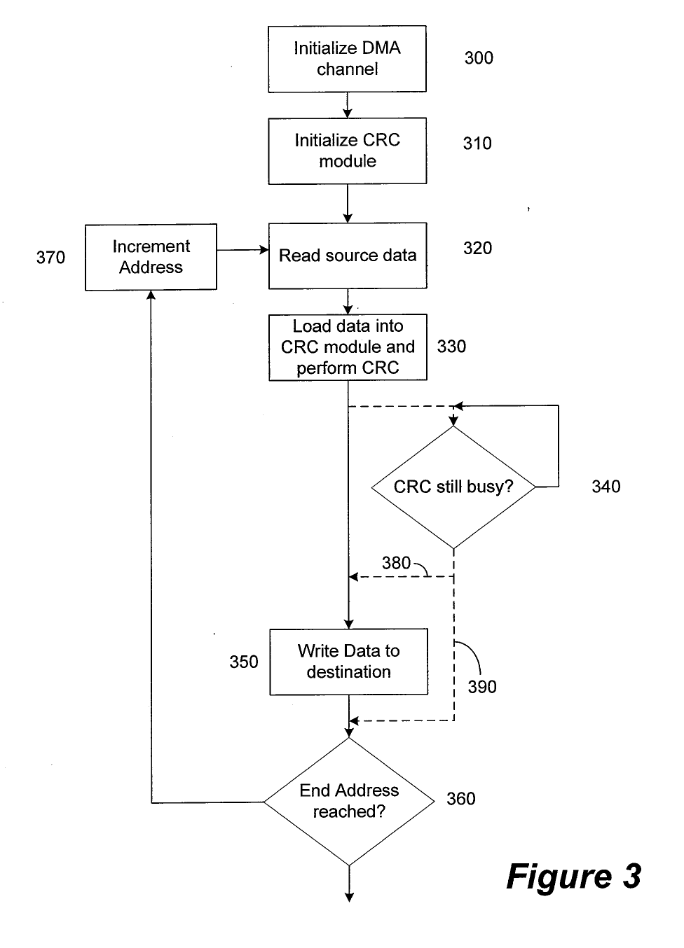

FIG. 3 shows a flow chart of various DMA operations including a CRC operation using a DMA controller according to an embodiment. First, in step 300, a DMA channel is initialized by programming the respective registers of the DMA controller to perform a DMA transfer including a CRC. To this end, for example, the start and end address of the source and destination are defined. Alternatively, in another embodiment, the source and destination start addresses and the length of the data block to be transferred are defined. Source and destination addresses can be located in the memory, Flash, mapped peripheral memory space, etc. Furthermore, initialization of a channel also may include the channel number, the interrupt signals to be generated during and/or after the transmission, and other necessary control signals. Next, the CRC module will be initialized in step 310. To this end, for example, the polynomial length, the channel to which the CRC module is assigned and the feedback points can be defined in respective control registers. Once initialization has been properly performed, the respective DMA channel transmission is started. To this end, the first source data is read from the source address in step 320 and loaded into the respective shift register of the CRC module in step 330. Depending on the setup of the CRC module, the CRC algorithm can be applied to the data while at the same time the data is written to the destination address in step 350 as shown by the solid connection lines. Alternatively, it can be checked in step 340 whether the CRC module is still busy in step 340 and the transmission can be stalled until the CRC produces its result. As indicated with the broken lines, the routine may after completion of the CRC either continue with step 350 by following line 380 or skip the write step by following line 390. The latter in particular applies when the DMA controller is used to check the integrity of a previously programmed Flash memory. In such a case no writing of data to the destination will occur. in step 360 it is checked whether the last address or end of the data block has been reached and if true, the routine ends. Otherwise, the respective source and destination address are incremented in step 370 and the routine continues with step 320.

In case of an integrity check of a memory area following line 390 in FIG. 3, a destination address for writing the result of the CRC can be defined and the result can be written to that specified address. Also, the CRC module can generate respective interrupt signals indicating a successful or unsuccessful CRC.

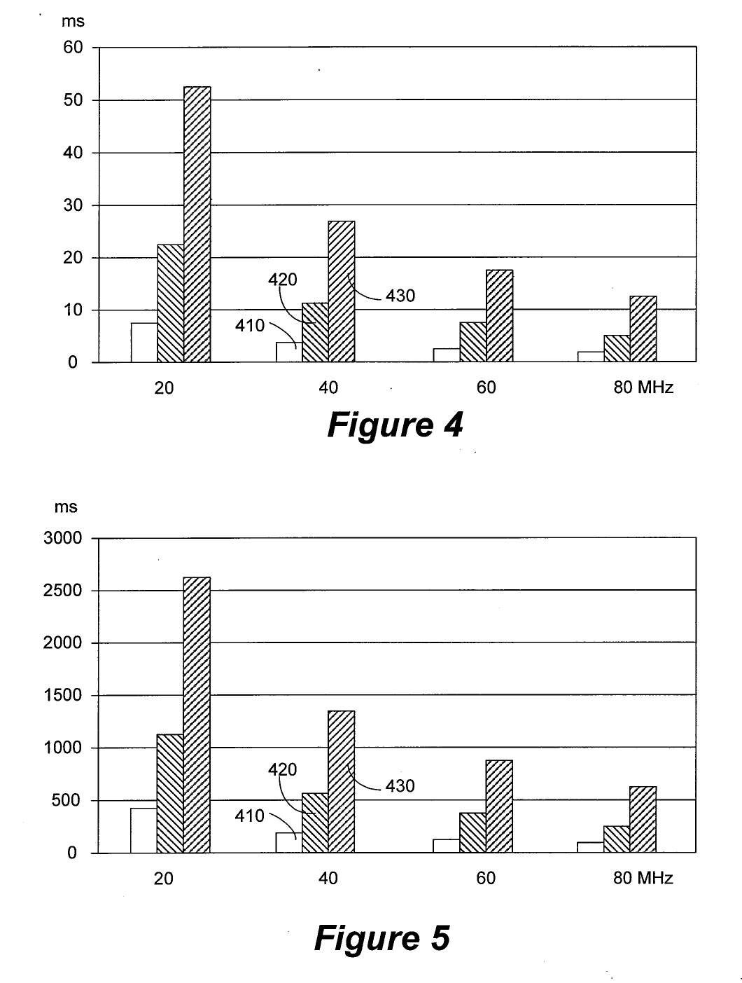

The advantages of a DMA controller with a hardware assisted CRC generator are shown in FIGS. 4 and 5. FIG. 4 illustrates a graph representing hardware efficiency of CRC time of RS-232 at 112 kbps, according to a specific example embodiment of this disclosure. The times for completing such a task are shown in the y-axis in milliseconds. The x-axis represents different clock speeds under which the DMA module may operate. Bars 410 represent a DMA controller according to an embodiment. Bars 420 represent a software CRC operation assisted by some dedicated hardware. Bars 430 represent a software CRC operation performed only by a central processing unit without hardware assist. FIG. 5 illustrates a similar graph as FIG. 4 representing hardware efficiency of CRC time of 512 kilobyte Flash memory, according to a specific example embodiment of this disclosure. The different bars correspond to the bars shown in FIG. 4. By using the DMA module to perform CRC calculations the CPU is free to perform other system related tasks.

The invention, therefore, is well adapted to carry out the objects and attain the ends and advantages mentioned, as well as others inherent therein. While the invention has been depicted, described, and is defined by reference to particular preferred embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described preferred embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A direct memory access (DMA) controller comprising:
a DMA bus;
a memory coupled to the DMA bus;
a DMA engine coupled with the DMA bus;
a cyclic redundancy check (CRC) module coupled with the DMA engine;
a bus interface coupled to the DMA engine and the CRC module.

2. The DMA controller according to claim 1, wherein the CRC module is coupled between the DMA engine and the DMA bus.

3. The DMA controller according to claim 1, wherein the DMA bus is a bus matrix.

4. The DMA controller according to claim 1, wherein the CRC module is programmable.

5. The DMA controller according to claim 4, wherein the CRC module comprises a shift register having a plurality of shift cells and associated taps coupled with a tap multiplexer providing an output signal that is fed back to the shift register.

6. The DMA controller according to claim 5, further comprising a plurality of XOR gates coupled with the plurality of taps and receiving the output signals of the tap multiplexer.

7. The DMA controller according to claim 6, further comprising a plurality of select multiplexers each selecting an output of one of the plurality of XOR gates or the tap of a shift cell.

8. The DMA controller according to claim 7, further comprising a control register for controlling the plurality of select multiplexers.

9. The DMA controller according to claim 5, further comprising a register for controlling the tap multiplexer.

10. A method of performing a direct memory access (DMA) transfer comprising the steps of:
a) initializing a DMA channel in a DMA controller;
b) initializing a cyclic redundancy check (CRC) module coupled with the DMA controller;
c) loading source data from a source address into the CRC module and starting a cyclic redundancy check algorithm on the loaded source data;
d) incrementing the source address;
e) repeating steps c) and d) until a source end address has been reached.

11. The method according to claim 10, wherein the step of loading source data comprises the step of directly loading the source data into the CRC module.

12. The method according to claim 10, wherein the step of loading source data comprises the step of loading the source data into the DMA controller and subsequently from the DMA controller into the CRC module.

13. The method according to claim 10, wherein the CRC module comprises a shift register having a plurality of shift cells and associated taps coupled with a tap multiplexer providing an output signal that is fed back to the shift register.

14. The method according to claim 13, wherein the CRC module further comprises a plurality of XOR gates coupled with the plurality of taps and receiving the output signals of the tap multiplexer.

15. The method according to claim 14, wherein the CRC module further comprises a plurality of select multiplexers each selecting an output of one of the plurality of XOR gates or the tap of a shift cell.

16. The method according to claim 13, wherein the step of initializing the CRC module comprises the step of loading a feedback point into a control register for controlling the tap multiplexer.

17. The method according to claim 13, wherein the step of initializing the CRC module comprises the step of loading a polynomial length into a register for controlling the plurality of select multiplexers.

18. The method according to claim 10, further comprising the step of writing a result of a CRC to a pre-determined memory location.

19. A direct memory access (DMA) controller comprising:
a bus matrix;
a memory coupled to the bus matrix;
a DMA engine coupled with the bus matrix;
a programmable cyclic redundancy check (CRC) module coupled between the DMA engine and the bus matrix;
a bus interface coupled to the DMA engine and the CRC module.

20. The DMA controller according to claim 19, wherein the CRC module comprises a shift register having a plurality of shift cells and associated taps coupled with a tap multiplexer providing an output signal that is fed back to the shift register.

21. The DMA controller according to claim 20, further comprising a plurality of XOR gates coupled with the plurality of taps and receiving the output signals of the tap multiplexer.

22. The DMA controller according to claim 21, further comprising a plurality of select multiplexers each selecting an output of one of the plurality of XOR gates or the tap of a shift cell.

23. The DMA controller according to claim 22, further comprising a control register for controlling the plurality of select multiplexers.

24. The DMA controller according to claim 20, further comprising a register for controlling the tap multiplexer.
